(19) United States
(12) Patent Application Publication
(10) Pub. No.: US 2025/0043760 A1
(43) Pub. Date: Feb. 6, 2025

(54) WATER TURBINE GENERATOR WITH BYPASS FLOW CONTROL

(71) Applicant: Hunter Industries, Inc., San Marcos, CA (US)

(72) Inventors: James A. Bell, Vista, CA (US); Daniel E. Hunter, Vista, CA (US); William Jason Mixter, IV, Livermore, CA (US)

(21) Appl. No.: 18/776,793

(22) Filed: Jul. 18, 2024

Related U.S. Application Data
(60) Provisional application No. 63/517,737, filed on Aug. 4, 2023.

(51) Int. Cl. F03B 3/00; F03B 11/00; F03B 13/10

(52) U.S. Cl. CPC F03B 3/00; F03B 11/004; F03B 11/008; F03B 13/10

(57) ABSTRACT

A device for generating electricity in an irrigation system includes a water turbine, a generator, and a bypass valve. The water turbine converts the flow of water in the irrigation system into rotational energy. The generator is connected to the water turbine for converting the rotational energy into electrical energy. The bypass valve assembly is in fluid communication with the water turbine and the irrigation system and is configured to regulate the flow of water through the water turbine and to direct excess water around the water turbine and back into the irrigation system. The device is configured to generate electricity while maintaining a predetermined flow rate in the irrigation system and to direct excess water around the water turbine and back into the irrigation system when the flow of water through the water turbine exceeds the predetermined flow rate.

### CROSS-REFERENCE TO RELATED APPLICATION

This application claims benefit under 35 U.S.C. 119 (e) to U.S. Provisional Patent Application No. 63/517,737, filed Aug. 4, 2023, the entire disclosure of which is hereby incorporated by reference herein in its entirety. Any and all priority claims identified in the Application Data Sheet, or any corrections thereto, are hereby incorporated by reference under 37 CFR 1.57.

### BACKGROUND

### Technical Field

The present disclosure relates to water turbines and electrical generation for irrigation systems.

### Description of the Related Art

Various attempts have been made to develop systems which harness irrigation flow to generate electricity. However, these systems suffer deficiencies including cost, size, reliability, and complexity or are otherwise unable to provide consistent control over the flow of water through the turbine and thus provide stable electrical current generation. Furthermore, irrigation system components often require tight control of pressure drops within the system in order to have sufficient pressure at various outlets throughout the system. Serviceability may present issues in some systems when internal components such as turbines, generators, and valves fail, leaving full replacement as the only option.

### SUMMARY

The utilization of a water turbine to harness the power of flowing water within an irrigation pipe for electricity generation presents vast potential. By strategically placing a water turbine within the pipeline, the kinetic energy of the flowing water is efficiently converted into mechanical energy. This mechanical energy is then further transformed into electrical energy through the integration of an electrical generator. The generated electricity can be utilized to power various components within the irrigation system, such as pumps, sensors, or even be directed towards the electrical grid or battery storage systems. This innovative approach not only offers a sustainable and renewable source of electricity but also optimizes the efficiency of the irrigation system, resulting in a greener and more efficient water management solution.

An aspect is directed to a water turbine system for generating electricity in an irrigation system that includes a pipeline configured to flow water. The system comprises a water turbine positioned in the pipeline and configured to convert kinetic energy of the water into mechanical energy, an electrical generator coupled to the water turbine and configured to convert the mechanical energy into electrical energy, a bypass valve positioned within the pipeline and configured to selectively divert a portion of the water away from the water turbine to control a flow rate and pressure of the water passing through the water turbine, and a control system configured to control a position of the bypass valve based on the desired flow rate and pressure of the water passing through the water turbine.

A variation of the aspect above further comprises a housing enclosing the water turbine and/or the electrical generator.

A variation of the aspect above is, wherein the electrical generator is configured to be connected to an electrical grid or a battery storage system to supply the generated electrical energy.

A variation of the aspect above is, wherein the control system includes at least one sensor configured to measure the flow rate and/or pressure of the water passing through the water turbine.

A variation of the aspect above is, wherein the bypass valve comprises an opening configured for flowing the portion of the water away from the water turbine.

A variation of the aspect above is, wherein a size of the opening is adjusted at least in part based on the measurements obtained from the at least one sensor.

A variation of the aspect above further comprises a monitoring system that displays real-time data regarding the electrical energy generated, the flow rate, the pressure, and a positional status of the bypass valve.

A variation of the aspect above further comprises a motorized mechanism configured to change the position of the bypass valve, and wherein the motorized mechanism is controlled by the control system.

A variation of the aspect above is, wherein the control system is configured to control a conversion efficiency of the water into the mechanical energy.

A variation of the aspect above is, wherein the bypass valve is further configured to automatically close when the flow rate and/or the pressure of the water falls below a predetermined threshold.

A variation of the aspect above further comprises a protective screen positioned upstream of the water turbine to prevent debris and/or solid particles from entering the water turbine and causing damage.

A variation of the aspect above is, wherein the pipeline is a pressurized pipe system supplying water to agricultural fields or landscaping areas.

An aspect is directed to a device for generating electricity in an irrigation system that includes a pipeline configured to flow water. The device comprises a water turbine for converting a flow of the water into rotational energy, a generator connected to the water turbine for converting the rotational energy into electrical energy, and a bypass valve in fluid communication with the water turbine and the irrigation system, the bypass valve being configured to regulate the flow of the water through the water turbine and to direct excess water around the water turbine and back into the irrigation system, wherein the device is configured to generate electricity while maintaining a predetermined flow rate in the irrigation system and to direct excess water around the water turbine and back into the irrigation system when the flow of water through the water turbine exceeds the predetermined flow rate.

A variation of the aspect above further comprises a control system configured to control a position of the bypass valve based at least in part on the predetermined flow rate.

A variation of the aspect above further comprises at least one sensor configured to measure the flow rate and/or pressure of the water passing through the water turbine.

An aspect is directed to a method for generating electricity in an irrigation system that includes a pipeline configured to flow water. The method comprises rotating a water turbine positioned in the pipeline to convert kinetic energy of the water into mechanical energy, converting the mechanical energy into electrical energy, and selectively diverting a portion of the water away from the water turbine to control a flow rate and pressure of the water passing through the water turbine.

A variation of the aspect above is, wherein selectively diverting the portion of the water comprises adjusting a size of an opening through which the portion of the water flows.

A variation of the aspect above further comprises measuring the flow rate and/or pressure of the water passing through the water turbine.

A variation of the aspect above is, wherein selectively diverting the portion of the water is based at least in part on the measurement of the flow rate and/or the pressure of the water.

A variation of the aspect above further comprises maintaining a predetermined flow rate in the irrigation system and directing excess water around the water turbine and back into the irrigation system when the flow of water through the water turbine exceeds the predetermined flow rate.

An aspect is directed to a water turbine system for generating electricity in an irrigation system. The system comprises a water turbine configured to convert the kinetic energy of flowing water into mechanical energy, an electrical generator coupled to the water turbine and configured to convert the mechanical energy into electrical energy, an irrigation pipeline through which water flows, wherein the water turbine is positioned within the irrigation pipeline to receive the flowing water and generate mechanical energy, a bypass valve assembly positioned within the irrigation pipeline that is configured to selectively divert a portion of the flowing water away from the water turbine to control the flow rate and pressure of water passing through the turbine, and a control system configured to monitor and adjust the opening of the bypass valve based on the desired flow rate and pressure of water passing through the water turbine.

A variation of the aspect above further comprises a housing enclosing the water turbine and electrical generator to protect them from environmental conditions.

A variation of the aspect above is, wherein the electrical generator is connected to an electrical grid or a battery storage system to supply the generated electrical energy.

A variation of the aspect above is, wherein the control system includes sensors to measure the flow rate and pressure of water passing through the water turbine, and wherein the opening of the bypass valve is adjusted based on the measurements obtained from the sensors.

A variation of the aspect above further comprises a monitoring system that displays real-time data regarding the electrical energy generated, flow rate, pressure, and status of the bypass valve.

A variation of the aspect above is, wherein the bypass valve is actuated by a motorized mechanism controlled by the control system.

A variation of the aspect above is, wherein the water turbine is designed to optimize the conversion efficiency of the flowing water into mechanical energy.

A variation of the aspect above is, wherein the bypass valve is further configured to automatically close when the flow rate or pressure of water falls below a predetermined threshold.

A variation of the aspect above further comprises a protective screen positioned upstream of the water turbine to prevent debris and solid particles from entering the turbine and causing damage.

A variation of the aspect above is, wherein the irrigation pipeline is a pressurized pipe system supplying water to agricultural fields or landscaping areas.

An aspect is directed to a device for generating electricity in an irrigation system. The device comprises a water turbine for converting the flow of water in the irrigation system into rotational energy, a generator connected to the water turbine for converting the rotational energy into electrical energy, a bypass valve assembly in fluid communication with the water turbine and the irrigation system, the bypass valve configured to regulate the flow of water through the water turbine and to direct excess water around the water turbine and back into the irrigation system, and wherein the device is configured to generate electricity while maintaining a predetermined flow rate in the irrigation system and to direct excess water around the water turbine and back into the irrigation system when the flow of water through the water turbine exceeds the predetermined flow rate.

### BRIEF DESCRIPTION OF THE DRAWINGS

The present disclosure is described with reference to the accompanying drawings, in which like reference characters reference like elements, and wherein:

FIG. 1 is a schematic view of a power system for an irrigation system according to the principles of the present disclosure.

FIG. 2 is a perspective view of a first embodiment of a turbine generator for an irrigation system according to the principles of the present disclosure.

FIG. 3 is a side view of the turbine generator of FIG. 2.

FIG. 4 is a cross-sectional view of the turbine generator of FIG. 3 along cut plane IV.

FIG. 5 is an exploded view of the turbine generator of FIG. 2.

FIG. 6 and FIG. 7 are side views of a bypass valve assembly of the turbine generator of FIG. 2 in closed and open positions, respectively.

FIG. 8 is a chart showing electrical current output by the turbine generator of FIG. 2 for various water flow rates through an irrigation system including the turbine generator.

FIG. 9 is a perspective view of a second embodiment of a turbine generator for an irrigation system according to the principles of the present disclosure.

FIG. 10 is a side view of the second embodiment of the turbine generator of FIG. 9.

FIG. 11 is a cross-sectional view of the turbine generator of FIG. 10 along cut plane XI.

FIG. 12 is an exploded view of the turbine generator of FIG. 9.

FIG. 13 is a perspective view of a third embodiment of a turbine generator for an irrigation system according to the principles of the present disclosure.

FIG. 14 is a side view of the third embodiment of the turbine generator of FIG. 13.

FIG. 15 is a cross-sectional view of the turbine generator of FIG. 14 along cut plane XV.

FIG. 16 is an exploded view of the turbine generator of FIG. 13.

FIG. 17 is a perspective view of a turbine generator including another exemplary bypass valve assembly.

FIG. 18 and FIG. 19 are cross-sectional views of the bypass valve assembly of the turbine generator of FIG. 17 in closed and open positions.

FIG. 20 is a schematic view of an exemplary turbine generator including an axial flow path.

FIG. 21 is a cross-sectional view of the turbine generator of FIG. 20.

### DETAILED DESCRIPTION

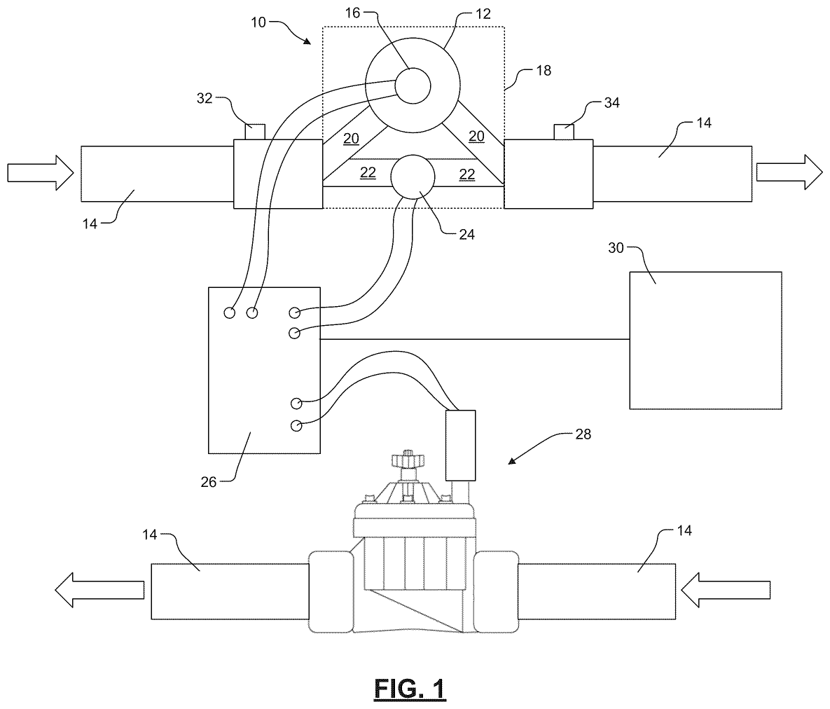

FIG. 1 illustrates a power system 10 for generating electricity for irrigation devices. The system 10 comprises a water turbine 12 designed to convert the kinetic energy of flowing water through an irrigation pipeline 14 into mechanical energy. An electrical generator 16 is coupled to the water turbine 12 to convert the mechanical energy into electrical energy. In certain embodiments, the water turbine 12 may be positioned within a housing 18 coupled to the irrigation pipeline 14. In this way, the water turbine 12 can receive the flowing water and generate mechanical energy.

The power system 10 may include one or more housing 18. In certain embodiments, the housing 18 may include passageways that split the flow of water and divert a portion of the water to a first passageway 20 to the water turbine 12 and another portion of the water to a second passageway 22 which bypasses the water turbine 12.

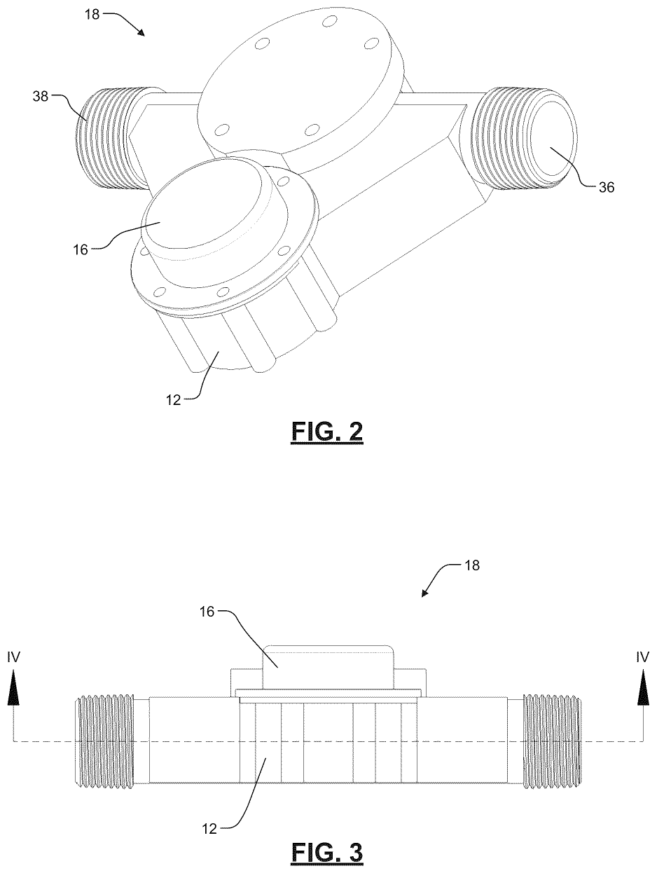

Referring now also to FIGS. 2-4, in certain embodiments, the housing 18 can be formed by injection molding or other manufacturing processes and incorporate the passageways 20 and 22 and other support structures therein. In certain embodiments, the housing 18 supports the water turbine 12 and/or the electrical generator 16. In certain embodiments, the housing 18 encloses the water turbine 12 and/or the electrical generator 16. In certain embodiments, the housing 18 serves to protect the water turbine 12 and/or the electrical generator 16 from environmental conditions, ensuring their longevity and reliability.

In certain embodiments, the housing 18 may also enclose the first passageway 20 and the second passageway 22. For example, in certain embodiments, the passageways 20 and 22 may be formed within the housing 18 through injection molding, boring, or the like. In the illustrated embodiment, the water turbine 12 is positioned within the first passageway 20. An inlet portion 20a of the first passageway 20 feeds water to the water turbine 12 while an outlet portion 20b of the first passageway 20 allows the water to exit the water turbine 12.

In certain embodiments, the power system 10 comprises a bypass valve assembly 24. The bypass valve assembly 24 is configured to control the flow rate and pressure of water passing through the water turbine 12 by opening and closing to divert more or less water through the bypass valve assembly 24. In the illustrated embodiment, the bypass valve assembly 24 is supported by the housing 18 and in flow communication with the second passageway 22. In certain embodiments, the bypass valve assembly 24 is positioned within the second passageway 22.

In the illustrated embodiment, an inlet portion 22a of the second passageway 22 is in flow communication with the bypass valve assembly 24 and feeds water through the bypass valve assembly 24 in an open configuration to an outlet portion 22b of the second passageway 22.

In the illustrated embodiment, the water turbine 12 rotates about an axis 19 that is perpendicular to a plane passing through the longitudinal axis of the bypass valve assembly 24. Advantageously, the bypass valve assembly 24 enables selective diversion of a portion of the flowing water away from the water turbine 12.

In certain embodiments, the electrical generator 16 in the power system 10 can be connected to an electrical grid or a battery storage system 26. This connection allows the generated electrical energy to be stored in chemical batteries as stored energy and later supplied to external sources, contributing to a reliable and sustainable power supply. For example, as shown in FIG. 1, the battery storage system 26 may be connected to an electric main valve 28 which may open and close using the stored energy even when no electrical energy is being generated by the electrical generator 16.

In FIG. 1, a control system 30 may also use the stored energy to store and execute one or more programs to operate the electric main valve 28. In certain embodiments, the electric main valve 28 can distribute water to various other irrigation components such as spray heads, rotors, dripline, and the like.

The power system 10 and the control system 30 may include one or more sensors 32. The one or more sensors 32 can be collocated with or remote from the power system 10 and/or the control system 30. For example, the one or more sensors 32 may be located on the power system 10 or at various other places. In certain embodiments, the one or more sensors 32 can be configured to measure the flow rate and pressure of water in the pipeline 14 or passageways 20 and 22. In this way, the one or more sensors 32 can enable the control system 30 to adjust the opening of the bypass valve assembly 24.

For example, in certain embodiments, a first sensor 32 may be positioned near the inlet of the bypass valve assembly 24 to measure at least one of flow rate and pressure at the inlet of the power system 10. Likewise, a second sensor 34 may be positioned near the outlet of the bypass valve assembly 24 to measure at least one of flow rate and pressure at the outlet of the power system 10. This functionality ensures optimal performance and efficiency of the power system 10 while maintaining sufficient flow and pressure through the pipeline 14 for any attached irrigation components. In other examples, opening of the bypass valve assembly 24 may be achieved mechanically. For example, FIGS. 2-5 illustrate an exemplary power system 10 that includes a spring-biased bypass valve assembly 124.

In certain embodiments, the housing 18 includes an inlet coupling 36 and an outlet coupling 38. The couplings 36 and 38 may be threaded as shown or may be configured for gluing to the pipeline 14. A valve cover 40 may be coupled with the housing 18 to enable access to the bypass valve assembly 24. A turbine cover 42 may be coupled with the housing 18 to enable access to the water turbine 12 and the electrical generator 16. In certain embodiments, the covers 40, 42 may be fixed to the housing 18 using fasteners (not shown).

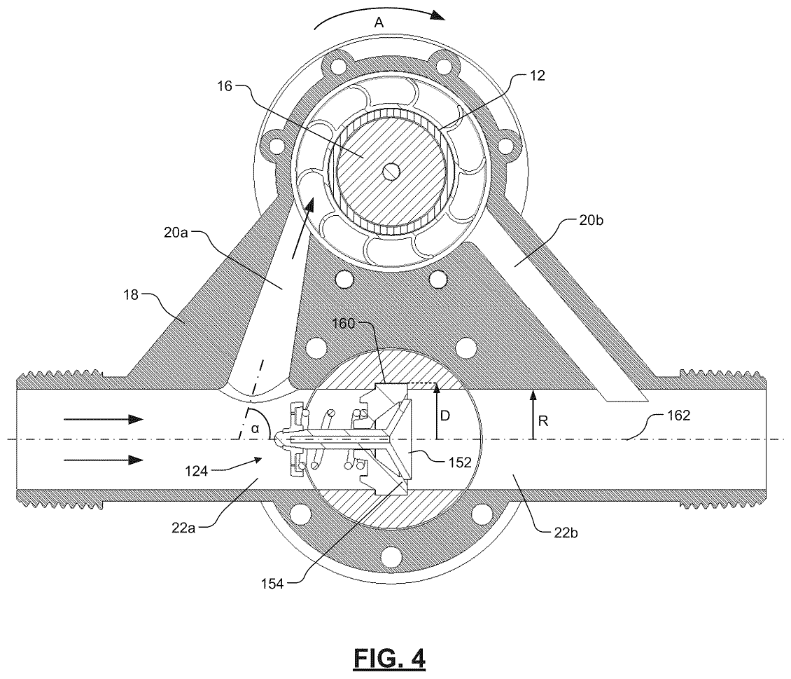

In the illustrated embodiment, the water turbine 12 includes blades 44. In FIG. 4, the water turbine 12 includes ten blades 44 though more or fewer blades may be used. In the illustrated embodiment, each blade 44 includes curvature to capture water leaving the inlet portion 20a and maximize the transfer of kinetic energy from the flow of the water to rotate the electrical generator 16. In certain embodiments, the water turbine 12 may be coupled with the electrical generator 16 by a turbine shaft 46.

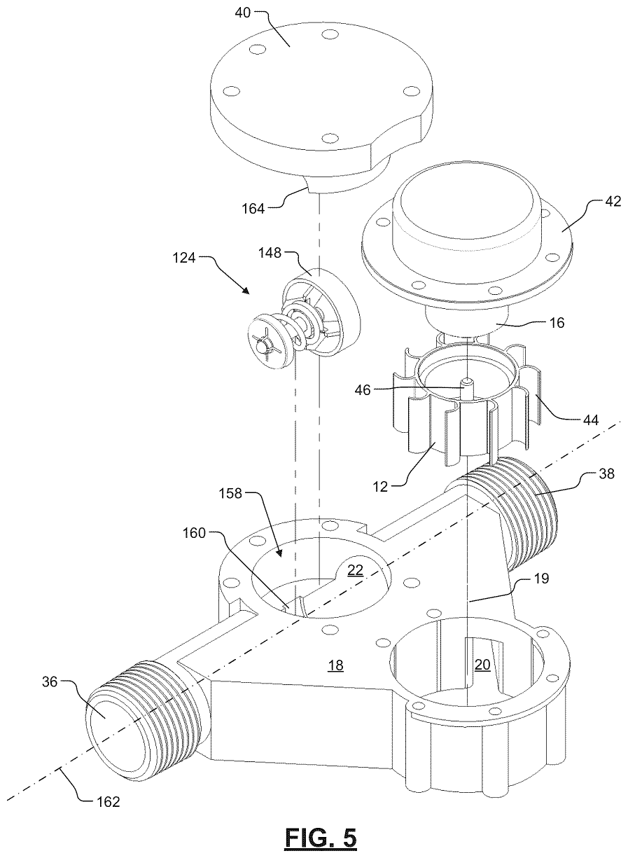

In the illustrated embodiment, the bypass valve assembly 124 includes a mount 148, a stem 150, a head 152, a seat 154, and a bias spring 156. In certain embodiments, the mount 148 is configured to couple with the second passageway 22. For example, as illustrated in FIG. 4 and FIG. 5, a chamber 158 within the second passageway 22 includes one or more features to receive the mount 148. The one or more features can be positioned within the chamber 158 to align the bypass valve assembly 124 with the flow of water through the second passageway 22.

For example, in certain embodiments, the one or more features can include a first recess 160 formed in the chamber 158. The first recess 160 can be configured to enable the bypass valve assembly 124 to slide in and out of the housing 18 for easier serviceability when the valve cover 40 is removed. In the illustrated embodiment, the chamber 158 is substantially cylindrical and perpendicular to a plane passing through the longitudinal axis 162 of the second passageway 22. In the illustrated embodiment, the first recess 160 is substantially cylindrical and aligned about the longitudinal axis 162. For example, the first recess 160 may be formed by a radial cut into the wall of the second passageway 22. In the illustrated embodiment, the radial cut has a depth D measured from the longitudinal axis 162 that is greater than a radius R measured from the longitudinal axis 162.

As illustrated in FIG. 4, a first side of the mount 148 engages with the first recess 160 as the bypass valve assembly 124 is placed into the chamber 158 when the valve cover 40 is removed. The valve cover 40 may include a mating second recess 164 facing opposite to the first recess 160 of the chamber 158. As the valve cover 40 is placed onto the housing 18, a second side of the mount 148 engages with the second recess 164. Once assembled, the first recess 160 and the second recess 164 retain and align the bypass valve assembly 124 within the second passageway 22.

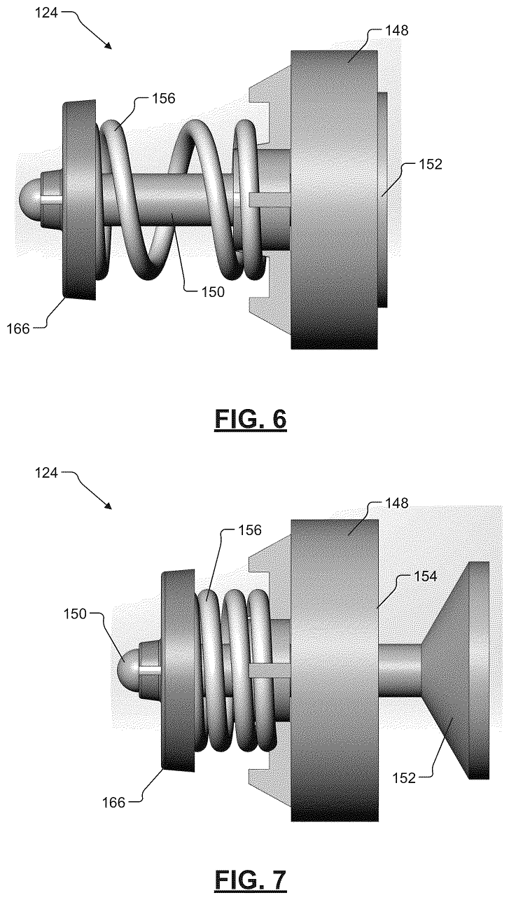

The bypass valve assembly 124 is shown in a closed configuration and an open configuration in FIG. 6 and FIG. 7, respectively. In certain embodiments, the mount 148 includes an opening that receives the stem 150. In certain embodiments, a spring retainer 166 is coupled to an upstream side of the stem 150 and engages the bias spring 156. In certain embodiments, the bias spring 156 is disposed between the spring retainer 166 and an upstream side of the mount 148. In certain embodiments, the head 152 is coupled to a downstream side of the stem 150 and is configured to engage the seat 154 of the mount 148. In certain embodiments, the bias spring 156 applies a spring force having a spring constant K to the stem 150 sufficient to bias the head 152 into contact with the seat 154 when the pressure on the upstream side of the bypass valve assembly 124 is less than a predetermined threshold.

For example, depending on the flow of water through the pipeline 14, the bypass valve assembly 124 may be forced closed by the bias spring 156 or opened by the pressure of the water. Under low flow conditions, most or all of the water may be diverted to the first passageway 20 as the pressure in the pipeline 14 is not sufficient to overcome the force of the bias spring 156 to open the bypass valve assembly 124. As the flow of water through the pipeline 14 increases, the pressure of the water on the head 152 increases, the force of the bias spring 156 may not be sufficient to keep the bypass valve assembly 124 closed. Water may begin to be diverted through the second passageway 22. Although the valve assembly 124 is shown in fully open and fully closed configurations, the head 152 and seat 154 may be positioned in a partially open configuration as well depending on flow rates and pressures.

The bias spring 156 is shown as a coil spring and is in compression when the valve assembly 124 is open. However, various bias springs 156 may function in a similar manner whether in compression or extension and fall within the scope of this disclosure.

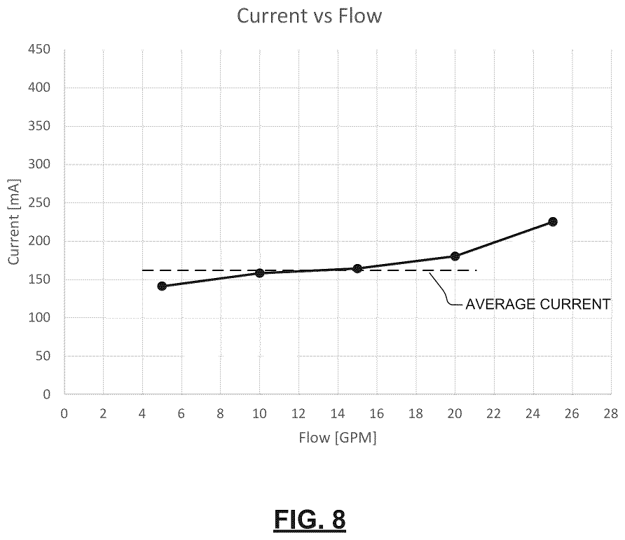

FIG. 8 illustrates the electrical current created by the electrical generator 16 for various flowrates of water through the pipeline 14. The data demonstrates that the exemplary bypass valve assembly 124 is capable of consistently controlling the flow of water through the water turbine 12 to produce power at a relatively stable current. For example, the current is shown as being relatively stable from approximately 5 gallons per minute (GPM) to 20 GPM. As shown in the chart, the average current produced is 160 mA with a standard deviation of about 10% or 16 mA.

Although the inlet portion 20a of the water turbine 12, as illustrated in FIGS. 2-8, includes a single opening directed towards a single blade 44 of the water turbine 12, other turbine designs could be implemented depending on the desired flow rates through the turbine generator. For example, at lower flow rates with lower pressures, a propeller-type turbine may be used. In some examples, the angle of the blades 44 of the water turbine 12 may be adjustable. For medium flow rates with medium to higher pressures, a Francis water turbine may be used. For higher pressures, a Pelton water turbine may be used.

The water turbine 12 may receive the flow of water from one or more openings in the inlet portion 20a. For example, the inlet portion 20a may include a tapered diameter that wraps partially around the water turbine 12 to deliver water to multiple blades 44 of the water turbine 12. In some examples, the inlet portion 20a may feed the water turbine 12 to rotate in a first direction A as shown in FIG. 4 that is clockwise. In other examples, an angle α of the inlet portion 20a relative to the axis 162 may be adjusted to impact the blades 44 of the water turbine 12 to rotate in a second direction (not shown) that is counterclockwise. Likewise, the water turbine 12 may be oriented in other configurations to accommodate different styles of turbines 12 and flow rates as well as packaging and serviceability concerns.

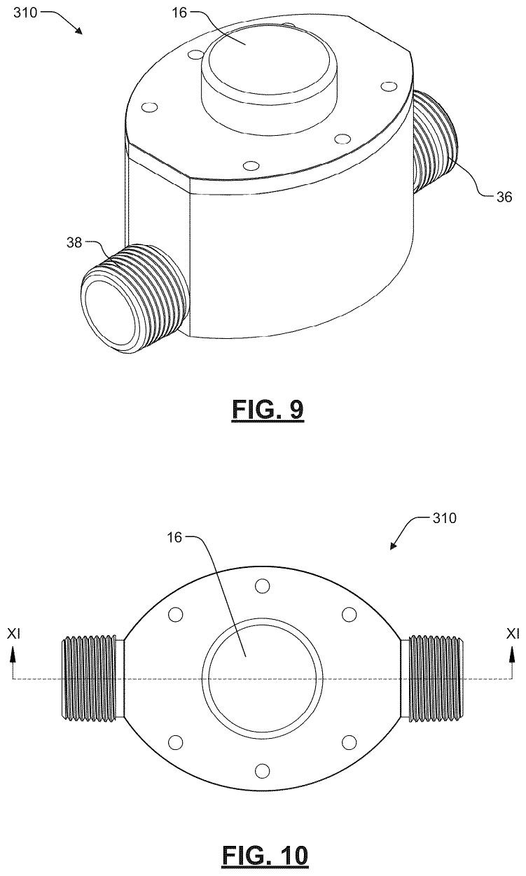

In the example of FIGS. 2-8, the power system 10 includes a “side-by-side” configuration with the turbine 12 rotating about an axis perpendicular to the radius R of the second passageway 22. FIGS. 9-12 illustrate another example of a power system 310 with similar features as the power system 10. The power system 310 is in an alternate arrangement of the same or similar components but in a “vertical stack” configuration. For example, the water turbine 12 rotates about an axis that is parallel to the radius of the second passageway 22. In the illustrated embodiment, a single cover 342 is used to enclose the water turbine 12, the generator 16, and the bypass valve assembly 124 within a housing 318. The bypass valve assembly 124 may be enclosed by the first recess 160 and a second recess 364 formed within a valve cover 340. In this configuration, the second passageway 22 is straight.

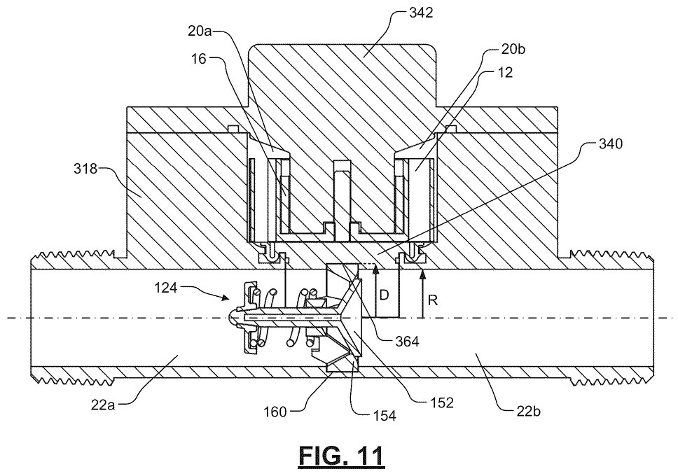

The bypass valve assembly 124 is shown in a closed configuration in FIG. 11. In certain embodiments, the mount 148 includes an opening that receives the stem 150. In certain embodiments, the spring retainer 166 is coupled to an upstream side of the stem 150 and engages the bias spring 156. In certain embodiments, the bias spring 156 is disposed between the spring retainer 166 and the upstream side of the mount 148. In certain embodiments, the head 152 is coupled to the downstream side of the stem 150 and is configured to engage the seat 154 of the mount 148. In certain embodiments, the bias spring 156 applies a spring force having a spring constant K to the stem 150 sufficient to bias the head 152 into contact with the seat 154 when the pressure on the upstream side of the bypass valve assembly 124 is less than a predetermined threshold.

For example, depending on the flow of water through the pipeline 14, the bypass valve assembly 124 may be forced closed by the bias spring 156 or opened by the pressure of the water. Under low flow conditions, most or all of the water may be diverted to the first passageway 20 as the pressure in the pipeline 14 is not sufficient to overcome the force of the bias spring 156 to open the bypass valve assembly 124. As the flow of water through the pipeline 14 increases, the pressure of the water on the head 152 increases, the force of the bias spring 156 may not be sufficient to keep the bypass valve assembly 124 closed. Water may begin to be diverted through the second passageway 22. Although the valve assembly 124 is shown in a fully closed configuration, the head 152 and seat 154 may be positioned in a partially open configuration as well depending on flow rates and pressures.

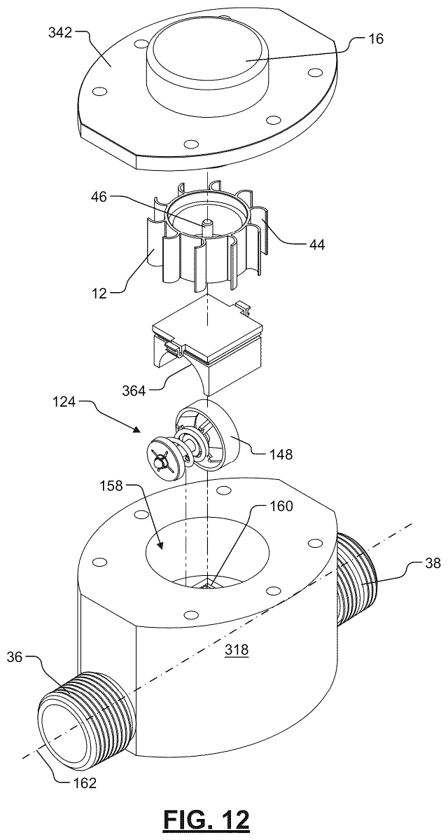

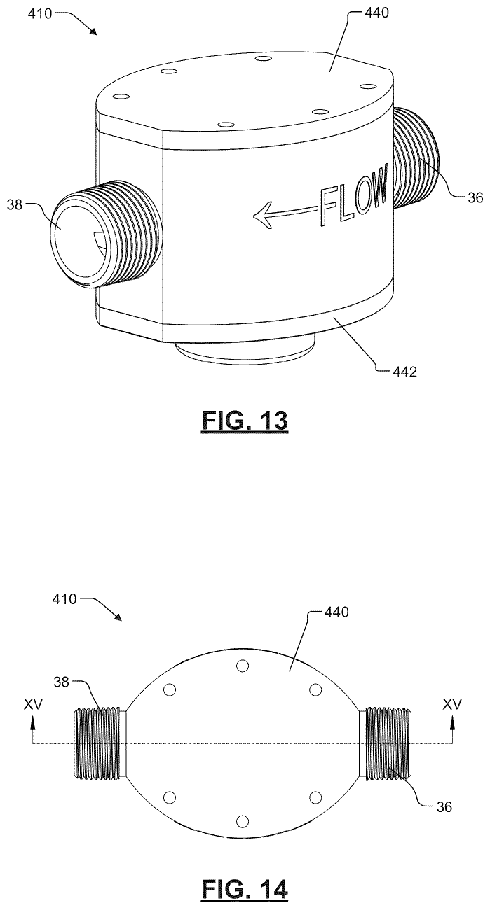

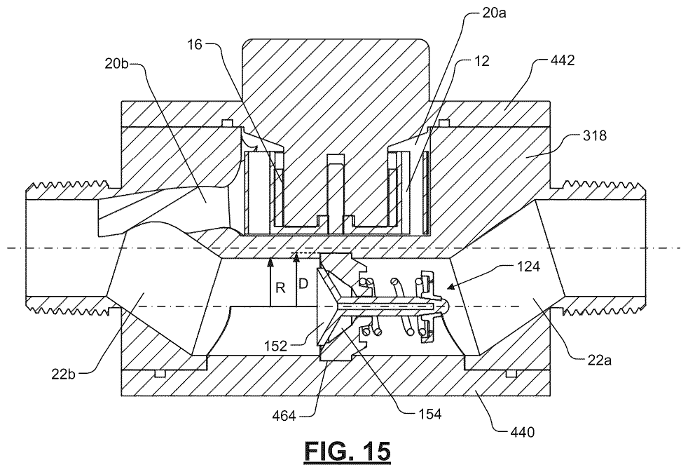

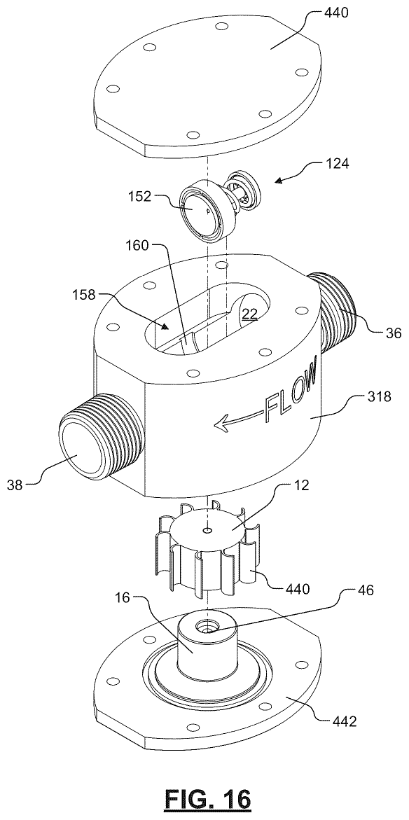

FIGS. 13-16 illustrate another example of a power system 410 with similar features as power system 10. In the embodiment illustrated in FIGS. 13-16, the power system 410 has an alternate arrangement of the same or similar components in a “split stack” configuration. For example, the water turbine 12 is configured to rotate about an axis that is parallel to the radius of the second passageway 22. In the illustrated embodiment, a turbine cover 442 encloses the water turbine 12 and the generator 16 within the housing 318 on one side. A valve cover 440 encloses the bypass valve assembly 124 between the first recess 160 and a second recess 464 formed within the valve cover 440.

The bypass valve assembly 124 is shown in a closed configuration in FIG. 15. In certain embodiments, the mount 148 includes an opening that receives the stem 150. In certain embodiments, the spring retainer 166 is coupled to an upstream side of the stem 150 and engages the bias spring 156. In certain embodiments, the bias spring 156 is disposed between the spring retainer 166 and the upstream side of the mount 148. In certain embodiments, the head 152 is coupled to the downstream side of the stem 150 and is configured to engage the seat 154 of the mount 148. In certain embodiments, the bias spring 156 applies a spring force having a spring constant K to the stem 150 sufficient to bias the head 152 into contact with the seat 154 when the pressure on the upstream side of the bypass valve assembly 124 is less than a predetermined threshold.

For example, depending on the flow of water through the pipeline 14, the bypass valve assembly 124 may be forced closed by the bias spring 156 or opened by the pressure of the water. Under low flow conditions, most or all of the water may be diverted to the first passageway 20 as the pressure in the pipeline 14 is not sufficient to overcome the force of the bias spring 156 to open the bypass valve assembly 124. As the flow of water through the pipeline 14 increases, the pressure of the water on the head 152 increases, the force of the bias spring 156 may not be sufficient to keep the bypass valve assembly 124 closed. Water may begin to be diverted through the second passageway 22. Although the valve assembly 124 is shown in a fully closed configuration, the head 152 and seat 154 may be positioned in a partially open configuration as well depending on flow rates and pressures.

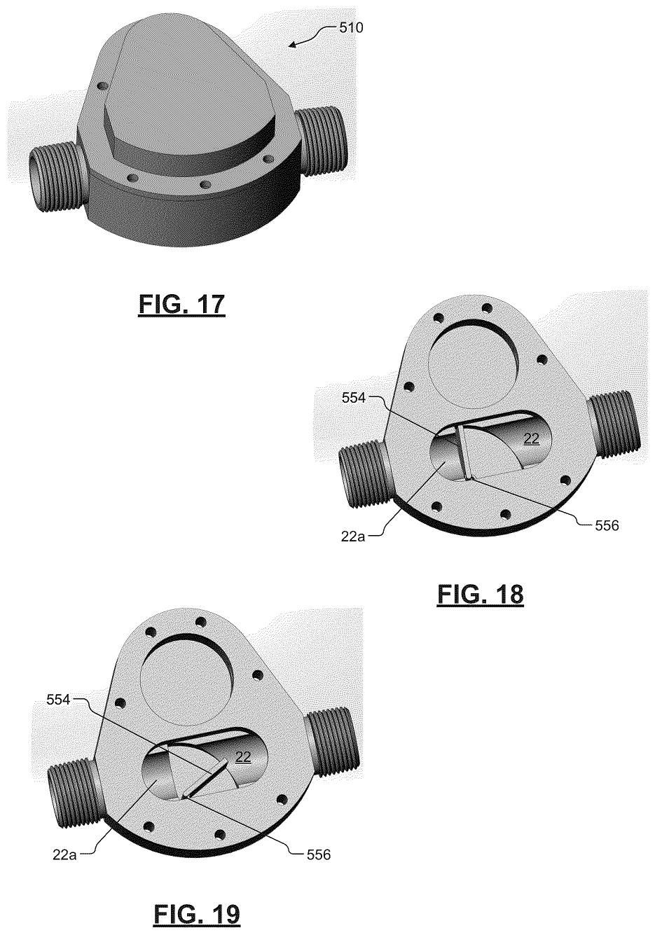

FIGS. 17-19 illustrate another exemplary power system 510 including another embodiment of a bypass valve assembly 524. In the illustrated embodiment, the bypass valve assembly 524 includes a flap seal 554 and a bias spring 556. In certain embodiments, the bias spring 556 is configured to force the flap seal 554 to a closed position shown in FIG. 18 when pressure in the inlet portion 22a of the second passageway 22 is insufficient to counter the spring force. In FIG. 19, the pressure in the inlet portion 22a is sufficient to overcome the spring force and moves the flap seal 554 to an open position.

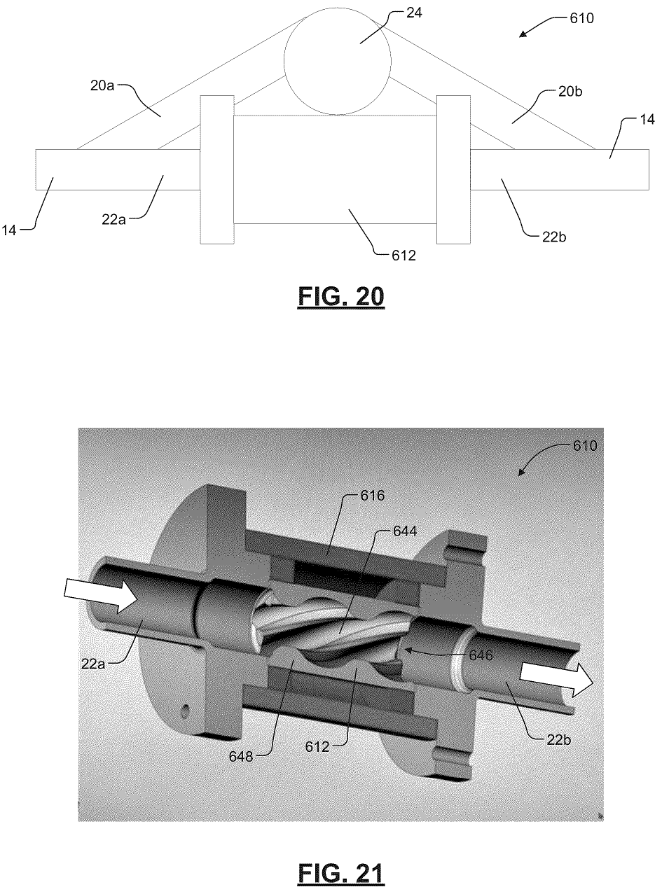

FIGS. 20-21 illustrate another exemplary power system 610 including an axial flow water turbine 612. Unlike the water turbines of the previous examples, water flows from the pipeline 14 directly through the water turbine 612 along an axis of rotation of the water turbine 612. For example, the water turbine 612 may include a substantially cylindrical shape with a hollow core 646. In certain embodiments, the hollow core 646 comprises a plurality of channels 644 formed in a wall 648 about the hollow core 646. In certain embodiments, the plurality of channels 644 wrap about the wall 648 in a helical or rifled pattern. As water enters the hollow core 646, some water flows into the plurality of channels 644 and applies pressure causing the water turbine 612 to rotate.

The water turbine 612 can comprise magnets. For example, in certain embodiments, the magnets are configured to create power through a generator 616. Although FIG. 20 includes a bypass valve 24, the power system 610 may function without any bypass flow. However, in some examples, such as when variable flow rates may occur, the bypass valve 24 may open to allow any excess water to bypass the water turbine 612, thus preventing damage to components such as bearings or electronic circuitry connected to the generator 616 due to increased power output.

For expository purposes, the term “horizontal” as used herein is defined as a plane parallel to the plane or surface of the floor of the area in which the system being described is used or the method being described is performed, regardless of its orientation. The term “floor” floor can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

The terms “approximately”, “about”, “generally” and “substantially” as used herein represent an amount close to the stated amount that still performs a desired function or achieves a desired result. For example, the terms “approximately”, “about”, “generally,” and “substantially” may refer to an amount that is within less than 10% of the stated amount.

What is claimed is:

1. A water turbine system for generating electricity in an irrigation system that includes a pipeline configured to flow water, comprising:
a water turbine positioned in the pipeline and configured to convert kinetic energy of the water into mechanical energy;
an electrical generator coupled to the water turbine and configured to convert the mechanical energy into electrical energy;
a bypass valve positioned within the pipeline and configured to selectively divert a portion of the water away from the water turbine to control a flow rate and pressure of the water passing through the water turbine; and
a control system configured to control a position of the bypass valve based on the desired flow rate and pressure of the water passing through the water turbine.

2. The water turbine system according to claim 1, further comprising a housing enclosing the water turbine and/or the electrical generator.

3. The water turbine system according to claim 1, wherein the electrical generator is configured to be connected to an electrical grid or a battery storage system to supply the generated electrical energy.

4. The water turbine system according to claim 1, wherein the control system includes at least one sensor configured to measure the flow rate and/or pressure of the water passing through the water turbine.

5. The water turbine system according to claim 4, wherein the bypass valve comprises an opening configured for flowing the portion of the water away from the water turbine.

6. The water turbine system according to claim 5, wherein a size of the opening is adjusted at least in part based on the measurements obtained from the at least one sensor.

7. The water turbine system according to claim 1, further comprising a monitoring system that displays real-time data regarding the electrical energy generated, the flow rate, the pressure, and a positional status of the bypass valve.

8. The water turbine system according to claim 1, further comprising a motorized mechanism configured to change the position of the bypass valve, and wherein the motorized mechanism is controlled by the control system.

9. The water turbine system according to claim 1, wherein the control system is configured to control a conversion efficiency of the water into the mechanical energy.

10. The water turbine system according to claim 1, wherein the bypass valve is further configured to automatically close when the flow rate and/or the pressure of the water falls below a predetermined threshold.

11. The water turbine system according to claim 1, further comprising a protective screen positioned upstream of the water turbine to prevent debris and/or solid particles from entering the water turbine and causing damage.

12. The water turbine system according to claim 1, wherein the pipeline is a pressurized pipe system supplying water to agricultural fields or landscaping areas.

13. A device for generating electricity in an irrigation system that includes a pipeline configured to flow water, comprising:
a water turbine for converting a flow of the water into rotational energy;
a generator connected to the water turbine for converting the rotational energy into electrical energy; and
a bypass valve in fluid communication with the water turbine and the irrigation system, the bypass valve being configured to regulate the flow of the water through the water turbine and to direct excess water around the water turbine and back into the irrigation system,
wherein the device is configured to generate electricity while maintaining a predetermined flow rate in the irrigation system and to direct excess water around the water turbine and back into the irrigation system when the flow of water through the water turbine exceeds the predetermined flow rate.

14. The device according to claim 13, further comprising a control system configured to control a position of the bypass valve based at least in part on the predetermined flow rate.

15. The device according to claim 13, further comprising at least one sensor configured to measure the flow rate and/or pressure of the water passing through the water turbine.

16. A method for generating electricity in an irrigation system that includes a pipeline configured to flow water, comprising:
rotating a water turbine positioned in the pipeline to convert kinetic energy of the water into mechanical energy;
converting the mechanical energy into electrical energy; and
selectively diverting a portion of the water away from the water turbine to control a flow rate and pressure of the water passing through the water turbine.

17. The method of claim 16, wherein selectively diverting the portion of the water comprises adjusting a size of an opening through which the portion of the water flows.

18. The method of claim 16, further comprising measuring the flow rate and/or pressure of the water passing through the water turbine.

19. The method of claim 18, wherein selectively diverting the portion of the water is based at least in part on the measurement of the flow rate and/or the pressure of the water.

20. The method of claim 16, further comprising:
maintaining a predetermined flow rate in the irrigation system; and
directing excess water around the water turbine and back into the irrigation system when the flow of water through the water turbine exceeds the predetermined flow rate.
